(19) United States
(12) Patent Application Publication
(10) Pub. No.: US 2006/0132977 A1
(43) Pub. Date: Jun. 22, 2006

(54) Magnetic head and head assembly

(75) Inventor: Fumiyuki Ito, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/097,934

(22) Filed: Mar. 31, 2005

(30) Foreign Application Priority Data
Dec. 21, 2004 (JP) 2004-368587

(51) Int. Cl. G11B 5/60

(52) U.S. Cl. 360/234.7

(57) ABSTRACT

A magnetic head, a head assembly, and a magnetic disk apparatus that uses the same make it possible to separately adjust the float of a write core and a read core in a magnetic head, and so make it possible to record and reproduce information more precisely. In a head assembly in which a magnetic head provided with a write core and a read core is mounted on a suspension, the write core and the read core are formed apart from one another on both side edges of a slider, and the direction of a line that joins the positions of the write core and the read core is perpendicular to a longitudinal direction of the suspension.

### BACKGROUND OF THE INVENTION

1. Field of the Invention

The present invention relates to a magnetic head and a head assembly, and in more detail to a magnetic head, a head assembly, and a magnetic disk apparatus that uses the same where the respective distances between a write core and a read core of the magnetic head and the medium can be adjusted in the state where a magnetic head floats above a medium.

2. Related Art

As shown in FIG. 4, in a magnetic disk apparatus 30, a magnetic disk 34 and an actuator 38 that swings and drives an arm 36 are disposed inside an enclosure 32, with a magnetic head 20 being mounted on the arm 36 via a suspension 22.

FIG. 5 shows a head assembly 40 that is formed of the magnetic head 20 and the suspension 22. A gimbal part 22b on which the magnetic head 20 is mounted is provided on the tip of a suspension main body 22a, and a wiring pattern 22c, which electrically connects the magnetic head 20 and a control circuit, is provided on the surface of the suspension main body 22a.

A read core and a write core for reading and writing information from and onto the magnetic disk 34 are formed on the magnetic head 20, with the magnetic head 20 being provided so as to float above the surface of the magnetic disk 34 due to an air flow produced by rotating the magnetic disk 34 and to read and write information from and onto the magnetic disk 34.

FIG. 6 shows a state where the magnetic head 20 floats above the surface of the magnetic disk 34 due to the magnetic disk 34 being rotated. In FIG. 6, a state where the write core 10 and the read core 12 are formed on the end of a slider 20a is schematically shown.

Patent Document 1

Japanese Laid-Open Patent Publication No. 2000-207860

However, in recent years, as the capacities of media have increased, the recording densities of media have become much higher. As the recording density of a medium improves, to read and write information precisely from and onto the medium, it has become necessary to reduce the distance the magnetic head 20 floats above the medium surface to less than the conventional distance. However, when the float of the magnetic head is reduced, it becomes necessary to thoroughly reduce the fluctuation in float for the magnetic head. This is because when the float of the magnetic head is reduced, fluctuations in float have a larger effect on the occurrence of errors during the reading and writing of information compared to when the float is large.

In a conventional magnetic head, the write core 10 and the read core 12 are provided at extremely close positions, so that the distance by which the magnetic head floats above the surface of the medium is substantially equal for both the write core 10 and the read core 12. Accordingly, in the case of a conventional magnetic head, the float of the write core 10 and the read core 12 above the medium surface cannot be set separately.

### SUMMARY OF THE INVENTION

It is an object of the present invention to provide a magnetic head, a head assembly, and a magnetic disk apparatus using the same that make it possible to optimize the float during the recording and reproduction of information by a write core and a read core of a magnetic head used in a magnetic disk apparatus and that can prevent fluctuations in float, thereby making it possible to record and reproduce information with high precision.

To solve the above problems, a magnetic head according to the present invention includes a write core and a read core, wherein the write core and the read core are formed apart from one another at shifted positions on both side edges of a slider.

Also, the write core and the read core may be formed on a front end surface of a slider whose planar form is rectangular. By disposing the write core and the read core apart on the end surface of this type of slider, by adjusting the roll of a suspension on which the magnetic head has been mounted, it is possible to separately adjust the respective float distances from a medium surface to the write core and the read core.

Also, in a head assembly according to the present invention, a magnetic head provided with a write core and a read core is mounted on a suspension, wherein the write core and the read core are formed apart from one another at shifted positions on both side edges of a slider, and the direction of a line that joins the positions of the write core and the read core is perpendicular to a longitudinal direction of the suspension.

The suspension may be subjected to adjustment of roll that adjusts the respective float distances from a medium surface to the write core and the read core.

The adjustment of roll may be achieved by an operation that adjusts a tilt angle of the suspension about a central axis of the suspension in a width direction.

By adjusting the roll, it is possible to adjust the float distances of the write core and the read core of the magnetic head mounted on the head assembly to become optimal values.

A magnetic disk apparatus assembled using the head assembly described above can be provided as a highly precise and highly reliable apparatus.

According to the magnetic head and the head assembly according to the present invention, it is possible to separately adjust the float distances from the medium surface of the write core and the read core provided on the magnetic head, and by setting the optimal float distances to the write core and the read core, it is possible to record and reproduce information with high precision. Accordingly, by using the head assembly in a magnetic disk apparatus that uses a medium whose recording density is extremely high, it is possible to improve the reliability of the apparatus.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1A and FIG. 1B are diagrams useful in explaining the constructions of head assemblies used in a magnetic head according to the present invention and a conventional magnetic head, respectively;

FIGS. 2A and 2B are diagrams useful in explaining a method of adjusting the float of a write core and a read core by adjusting the roll of a suspension;

FIG. 3 is a diagram useful in explaining a method of adjusting the roll of the suspension;

FIG. 4 is a plan view showing a typical construction of a magnetic disk apparatus;

FIG. 5 is a perspective view of a head assembly; and

FIG. 6 is a diagram useful in explaining a state where a magnetic head floats above the surface of a medium.

### DESCRIPTION OF THE PREFERRED EMBODIMENTS

Preferred embodiments of the present invention will now be described in detail with reference to the attached drawings.

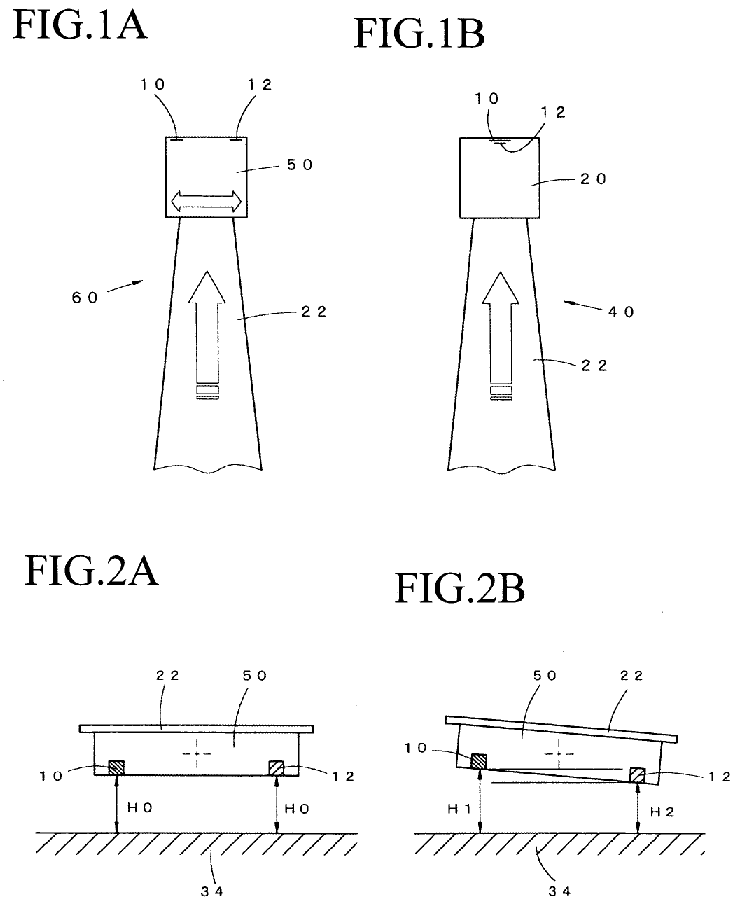

FIG. 1A schematically shows the construction of an embodiment of a magnetic head 50 and a head assembly 60 according to the present invention, while FIG. 1B schematically shows the construction of the conventional magnetic head 20 and the head assembly 40. The head assembly 60 is constructed with the magnetic head 50 on a gimbal part (not shown) of the suspension 22. FIGS. 1A and 1B show the constructions on the sides of the respective head assemblies that face magnetic disks.

In the magnetic head 50 of the present embodiment shown in FIG. 1A, the write core 10 and the read core 12 are provided at the tip of a slider so as to be apart from one another at shifted positions on both side edges of the slider.

On the other hand, in the conventional magnetic head 20 shown in FIG. 1B, the write core 10 and the read core 12 are disposed extremely close to one another at the tip of the slider.

A pattern that acts with an air flow generated when the medium is rotated so as to produce a force that floats the slider in a direction away from the surface of the medium and a pattern that acts with the air flow so as to produce a force (negative pressure) that pulls the slider toward the surface of the medium are formed on the floating surface (ABS surface) of the slider that composes the magnetic head 50. The float of the magnetic head 50 (a standard distance for the float) is determined by the balance between the floating force and the negative pressure.

The magnetic head 50 according to the present embodiment is characterized by making it possible to separately adjust the float of the write core 10 and the read core 12 by adjusting the roll of the suspension 22 about a central axis in the width direction relative to the standard float determined by factors such as the patterns provided on the floating surface of the slider.

Such adjustment is possible since the write core 10 and the read core 12 are formed separately and disposed apart from one another near both side edges of the slider whose planar form is rectangular and an alignment direction of the write core 10 and the read core 12 is perpendicular to (i.e., crosses) the central axis of the suspension 22 in the width direction. It should be noted that the expression “alignment direction of the write core 10 and the read core 12” refers to the direction of a line that joins the disposed positions of the write core 10 and the read core 12.

To show that the float of the write core 10 and the read core 12 can be separately adjusted by adjusting the roll of the suspension 22 about the central axis, FIGS. 2A and 2B show states where the magnetic head 50 floats above the surface of the magnetic disk 34 when looking from the front end surface of the magnetic head 50.

FIG. 2A shows the case where the surface of the suspension 22 is parallel with the surface of the magnetic disk 34, while FIG. 2B shows a state where the roll has been adjusted by rotating the suspension 22 about the central axis.

As shown in FIG. 2A, when the surface of the suspension 22 is parallel with the surface of the magnetic disk 34, the float of the write core 10 and the float of the read core 12 provided on the magnetic head 50 are equal at H0.

On the other hand, when the roll is adjusted by rotating the suspension 22 about the central axis, the float H1 of the write core 10 differs to the float H2 of the read core 12. In the illustrated example, an adjustment has been made so that the distance the write core 10 floats above the medium surface has been made larger than the distance the read core 12 floats above the medium surface (i.e., H1>H2).

The distances the write core 10 and the read core 12 respectively float above the medium surface are determined by the rotation direction and rotation angle used when the roll of the suspension 22 is adjusted and also by the distance between the write core 10 and the read core 12. Accordingly, by adjusting the amount of rotation of the suspension 22 with consideration to the disposed positions of the write core 10 and the read core 12 formed on the slider, it is possible to appropriately adjust the respective distances the write core 10 and the read core 12 float above the medium surface.

During actual design, the distance the write core 10 and the read core 12 float above the medium surface can be adjusted based on various factors, such as the standard float of the magnetic head 50 that depends on the design of the slider, the elasticity of the suspension 22, and the size of the slider.

When the recording density of a medium such as the magnetic disk 34 is extremely high, the optimal value of the float distance during the recording and reproduction of information using the write core 10 and the read core 12 may differ for the write core 10 and the read core 12. When the optimal value of the float distance differs between the write core 10 and the read core 12 in this way, a construction with the magnetic head 50 and the head assembly 60 according to the present embodiment can be effectively used.

As a method of adjusting the roll of the suspension 22, it is possible to use a method where laser light is shone onto the suspension 22 to cause plastic deformation of the metal composing the member of the suspension 22 due to heat.

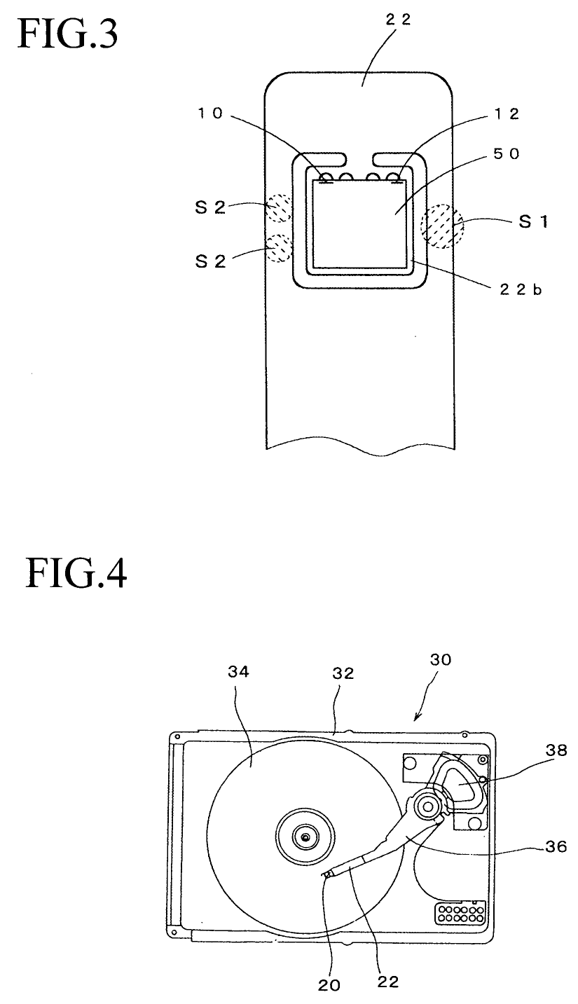

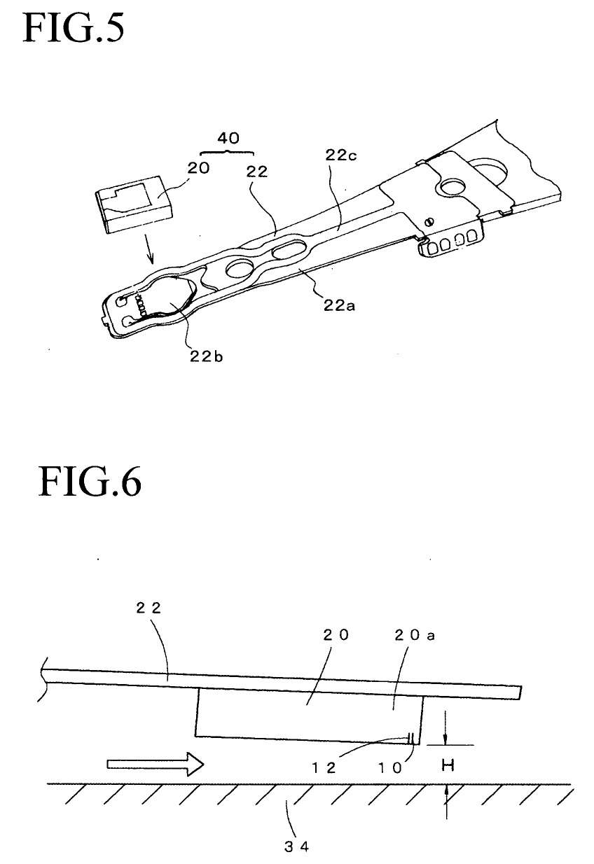

FIG. 3 shows a method that adjusts the roll by shining a laser light spot onto the suspension 22 to cause thermal deformation of the suspension 22. In FIG. 3, S1 and S2 indicate irradiation positions of the laser light. The roll of the suspension 22 can be adjusted by making appropriate adjustments, such as adjustments to the positions at which the laser light is shone including the front and rear surfaces of the suspension 22 and adjustments to the spot of the laser light.

The head assembly 60 on which the magnetic head 50 of the present embodiment is mounted can also be used so that when the magnetic head 50 has been attached in a tilted state during the assembly process where the magnetic head 50 is mounted on the suspension 22 or when the magnetic head 50 has been assembled at a position displaced from the correct position due to fluctuations during the manufacturing process of the suspension 22, the roll of the suspension 22 can be adjusted to correct the displacement of the magnetic head 50. When the recording density of the medium is improved and even higher precision is required for the attachment of the head assembly 60, it is necessary to carry out adjustment to correct fluctuations (tolerance) in the manufacturing process of products. The magnetic head and the head assembly according to the present invention can also be favorably used with the object of such adjustment.

Since adjustments can be achieved by such corrections, the magnetic head and head assembly according to the present invention can effectively reduce the rejection rate of products, which makes it possible to improve the yield of a head assembly that requires high precision.

By using the magnetic head according to the present invention and a head assembly on which this magnetic head has been mounted as assembled components, it is possible to provide a magnetic disk apparatus that is highly precise and has high reliability.

It should be noted that in the magnetic head 50 according to the present invention, the write core 10 and the read core 12 need to be formed at positions that are a predetermined distance apart, and as a method of forming the magnetic head 50 so that the write core 10 and the read core 12 are disposed apart on the slider, it is possible to use the manufacturing process of a conventional magnetic head where the write core 10 and the read core 12 are incorporated into the slider.

In the manufacturing process of a conventional magnetic head, the process that forms the write core 10 and the process that forms the read core 12 are separate processes, with the read core 12 being formed after the write core 10 has been formed. Accordingly, after the write core 10 has been formed, it is sufficient to form the read core 12 at a different position (a position that is the predetermined distance apart on the slider) to the write core 10. The write core 10 and/or the read core 12 is/are formed by a layer-forming process and an etching process or the like, with the layer-forming process and etching process making it easy to form elements at specified positions on a substrate.

What is claimed is:

1. A magnetic head comprising a write core and a read core, wherein the write core and the read core are formed apart from one another at shifted positions on both side edges of a slider.

2. A magnetic head according to claim 1, wherein the write core and the read core are formed on a front end surface of a slider whose planar form is rectangular.

3. A head assembly where a magnetic head provided with a write core and a read core is mounted on a suspension,
wherein the write core and the read core are formed apart from one another at shifted positions on both side edges of a slider, and
the direction of a line that joins the positions of the write core and the read core is perpendicular to a longitudinal direction of the suspension.

4. A head assembly according to claim 3, wherein the suspension is subjected to an adjustment of roll that adjusts the respective float distances from a medium surface to the write core and the read core.

5. A head assembly according to claim 4, wherein the adjustment of roll is achieved by an operation that adjusts a tilt angle of the suspension about a central axis of the suspension in a width direction.

6. A magnetic disk apparatus assembled using a head assembly according to claim 3.

7. A magnetic disk apparatus assembled using a head assembly according to claim 4.

8. A magnetic disk apparatus assembled using a head assembly according to claim 5.
